(19) United States
(12) Patent Application Publication
(10) Pub. No.: US 2014/0283555 A1
(43) Pub. Date: Sep. 25, 2014

(54) MOLDING APPARATUS AND MOLDING METHOD OF GLASS CASINGS

(71) Applicant: ASAHI GLASS COMPANY, LIMITED, Chiyoda-ku (JP)

(72) Inventor: Kenichi MASUDA, Tokyo (JP)

(73) Assignee: ASAHI GLASS COMPANY, LIMITED, Chiyoda-ku (JP)

(21) Appl. No.: 14/299,477

(22) Filed: Jun. 9, 2014

Related U.S. Application Data
(63) Continuation of application No. PCT/JP2012/083303, filed on Dec. 21, 2012.

(30) Foreign Application Priority Data
Jan. 5, 2012 (JP) 2012-000638

(51) Int. Cl. C03B 11/08; C03B 11/12

(52) U.S. Cl. CPC C03B 11/082; C03B 11/12; C03B 2215/80; C03B 2215/60; C03B 2215/414
USPC 65/106; 65/244

(57) ABSTRACT

The present invention provides a molding apparatus and a molding method of glass casings capable of improving a productivity of glass casings. In a molding apparatus 1 of glass casings being a molding apparatus of glass casings in which a plate-shaped glass material 50 is press-molded by molding molds formed of an upper mold unit 11 and a lower mold unit 12, and the molding apparatus has a heating plate 3b, pressing plates 4b and a cooling plate 5b performing a heating process, a pressing process and a cooling process, respectively, on the mounted glass material, and a control unit controlling the respective processes, and a plurality of upper molds and lower molds provided to the upper mold unit 11 and the lower mold unit 12 are respectively and independently held within each unit in a movable manner in a horizontal direction.

### CROSS-REFERENCE TO RELATED APPLICATIONS

This application is a continuation of prior International Application No. PCT/JP2012/083303, filed on Dec. 21, 2012 which is based upon and claims the benefit of priority from Japanese Patent Application No. 2012-000638 filed on Jan. 5, 2012; the entire contents of all of which are incorporated herein by reference.

### FIELD

The present invention relates to a molding apparatus and a molding method capable of continuously manufacturing glass casings through press-molding, and particularly relates to a molding apparatus and a molding method suppressing a generation of defective forms at a time of molding a plurality of glass casings through press-molding of one time.

### DISCUSSION OF THE BACKGROUND

Various methods of manufacturing press-molded products made of glass by heating and softening a glass material housed in a molding mold and pressing the material, have been used in recent years, and there has been proposed a manufacturing apparatus of continuously molding a plurality of press-molded products while conveying molding molds to respective processing stages, in order to reduce a manufacturing cost. Such a manufacturing apparatus is often used for manufacturing optical elements (refer to, JP-A No. H8-259240 (KOKAI), JP-A No. 2008-69019 (KOKAI), JP-A No. 2009-96676 (KOKAI), for example). Further, press-molding using rolling members for coaxially aligning molding molds of an optical element, has also been known (refer to International Publication WO 2008/053860).

In the manufacturing apparatus of the press-molded products as above, the molding molds are set to have a predetermined temperature when heating and softening the glass material and pressing the glass material to maintain a sufficient heating temperature for processing the glass material, the glass material is cooled to be solidified after the molding, and finally, cooling is conducted to a temperature of 200° C. or less at which the molding molds are not oxidized. As described above, a form of molding mold is accurately transferred to the glass material at the time of pressing, and the glass material is cooled and solidified to keep a molded form, to thereby manufacture a press-molded product with high accuracy of form.

Meanwhile, there is a remarkable progress regarding electronic products, and various portable electronic products are developed. Sizes and thicknesses of the forms of the electronic products are reduced, and as casings of such compact electronic products, casings using materials made of resin, metal, glass and the like have been known. If the casing of the electronic product as described above can employ the casing made of glass, there is an advantage that it is possible to provide an external appearance excellent in design and a high texture. Some casings are manufactured by methods of cutting, polishing and the like, and a manufacture through press-molding is also considered.

### SUMMARY OF THE INVENTION

The present invention provides a molding apparatus and a molding method of glass casings capable of improving a productivity of glass casings. In a molding apparatus of glass casings being a molding apparatus of glass casings in which a plate-shaped glass material is press-molded by molding molds formed of an upper mold unit and a lower mold unit, and the molding apparatus has a heating plate, pressing plates and a cooling plate performing a heating process, a pressing process and a cooling process, respectively, on the mounted glass material, and a control unit controlling the respective processes, and a plurality of upper molds and lower molds provided to the upper mold unit and the lower mold unit are respectively and independently held within each unit in a movable manner in a horizontal direction.

### BRIEF DESCRIPTION OF THE DRAWINGS

A more complete appreciation of the invention and many of the attendant advantages thereof will be readily obtained as the same becomes better understood by reference to the following the detailed description when considered in connection with the accompanying drawings.

FIG. 1 is a schematic configuration diagram of a molding apparatus of glass casings being one embodiment of the present invention.

FIG. 2 is a schematic configuration diagram in which the molding apparatus in FIG. 1 is seen from above.

FIG. 3 is a plan view of a lower mold unit used in the molding apparatus in FIG. 1.

FIG. 4 is a sectional side view of an upper mold unit and the lower mold unit in FIG. 1 at a cross section of A-A in FIG. 3.

FIG. 5 is a schematic configuration diagram of a molding apparatus of glass casings being another embodiment of the present invention.

### DETAILED DESCRIPTION

The embodiments will now be described with reference to the accompanying drawings, wherein like reference numerals designate corresponding or identical elements throughout the various drawings.

### Embodiment

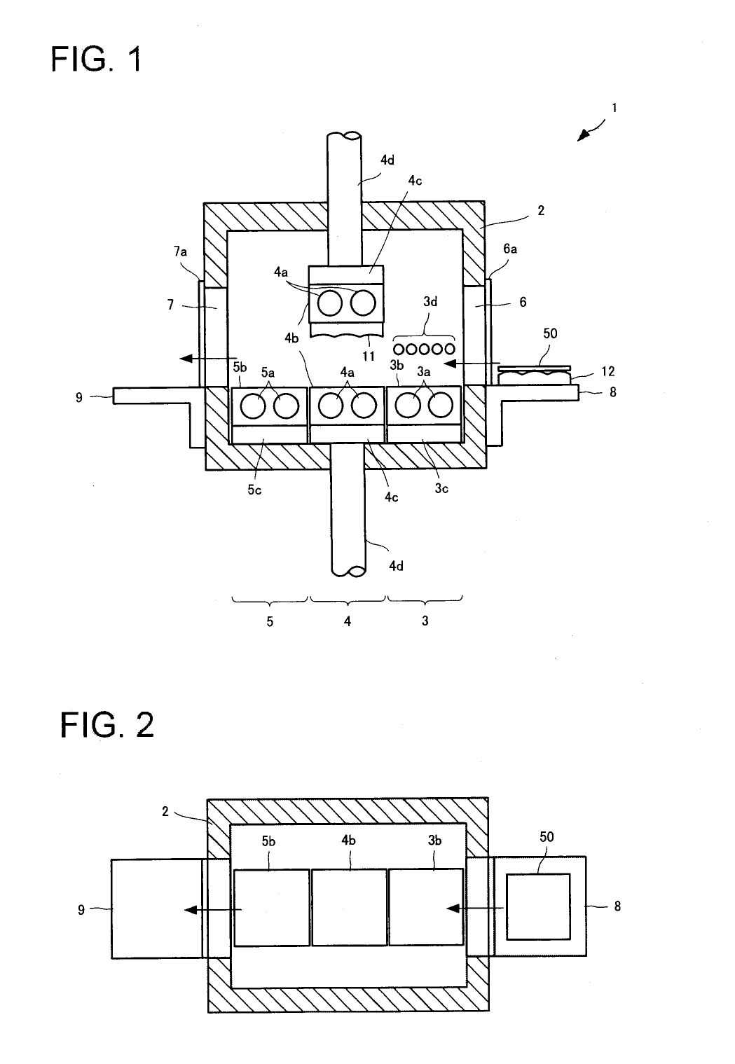

Hereinafter, the present invention will be described in detail. FIG. 1 is a schematic configuration diagram of a molding apparatus of glass casings being one embodiment of the present invention, and FIG. 2 is a schematic configuration diagram in which the molding apparatus in FIG. 1 is seen from above. (In both of FIG. 1 and FIG. 2, only a chamber 2 is illustrated by a cross section. Further, FIG. 2 illustrates only plates on a lower side of respective stages, and indicates a positional relationship of the plates in the respective stages.)

A molding apparatus 1 of glass casings of the embodiment of the present invention has: a chamber 2 to be a molding chamber for molding the glass casings, a heating stage 3 provided inside of the chamber 2, and heating a plate-shaped glass material 50 and a lower mold unit 12 on which the glass material is mounted to soften the glass material 50; a pressing stage 4 pressing the heated and softened plate-shaped glass material 50; and a cooling stage 5 cooling the glass material to which forms of the glass casings are given by the pressing.

Here, the chamber 2 being the molding chamber provides, in the inside thereof, a place for performing molding operation of the glass casings. The chamber 2 is provided with an inlet 6 through which the glass material 50 and the lower mold unit 12 are taken into the inside of the chamber 2, and an outlet 7 from which the molded glass material 50 and the lower mold unit 12 are taken out after the press-molding is completed, and to the inlet 6 and the outlet 7, an inlet shutter 6a and an outlet shutter 7a are respectively provided. The lower mold unit 12 can be taken into and taken out from the chamber 2 by opening and closing these shutters according to need, and an atmosphere in the chamber 2 is maintained. Further, to the inlet 6 and the outlet 7, molding mold mounting tables 8 and 9 on which the lower mold unit 12 can be mounted are respectively provided at portions outside of the chamber 2.

In the inside of the chamber 2, there are provided the heating stage 3, the pressing stage 4 and the cooling stage 5 for performing press-molding of the glass casings, and by these respective stages, processing is sequentially conducted to make the glass material have a desired form. Actually, the lower mold unit 12 on which the plate-shaped glass material 50 is mounted is taken into the chamber 2 from the inlet 6, moved in order by being subjected to predetermined processing in the above-described respective stages, and after the predetermined processing is completed, the lower mold unit 12 is taken out to the outside of the chamber 2 from the outlet 7.

Since the inside of the chamber 2 is heated to a high temperature to easily cause softening and deformation of the plate-shaped glass material 50, it is maintained to have an atmosphere of inert gas such as nitrogen so that the lower mold unit 12 and the upper mold unit 11 are not oxidized. The inert gas atmosphere can be achieved by making the chamber 2 have a sealed structure and replacing an inside atmosphere, and it is also possible to design such that the chamber 2 is made to have a semi-sealed structure, and the inert gas atmosphere is maintained so as to prevent an outside air from being flowed into the chamber while setting a pressure in the chamber to a positive pressure by constantly supplying inert gas into the chamber 2. The above-described inlet shutter 6a and outlet shutter 7a are effective for creating the semi-sealed state inside of the chamber 2 with a simple configuration. Note that it is preferable that these chamber 2 and shutters 6a, 7a are formed of materials of stainless steel, alloy steel or the like, from which gas and impurity are not precipitated under a high temperature. Further, it is also possible to make an outer periphery of the shutters 6a, 7a (including the molding mold mounting tables 8, 9) have a sealed structure, to further suppress the inflow of air from the outside into the chamber 2.

Next, the respective stages for performing the molding operation of the present invention will be described. Note that molding molds used for the press-molding of the glass material 50 in the embodiment are a set of molding mold units configured by an upper mold unit 11 having a plurality of upper molds forming casing forms of an upper surface, and the lower mold unit 12 having a plurality of lower molds forming casing forms of a lower surface. In the embodiment, the upper mold unit 11 is fixed in the pressing stage 4, and the lower mold unit 12 is set to move on the respective stages while mounting the glass material 50 thereon. Here, the molding mold units used in the embodiment have a plurality of sets of a pair of corresponding upper mold and lower mold, and it is possible to mold a plurality of glass casings by a pressing operation of one time. Further, the respective upper molds and lower molds are disposed so that they can move just a little in a horizontal direction.

The heating stage 3 of the embodiment has a heating plate 3b having a heater 3a embedded therein, for softening the glass material 50 mounted on the lower mold unit 12. The heating plate 3b heats the lower mold unit 12 by being brought into contact with the lower mold unit 12, and it can further heat the glass material 50 mounted on the lower mold unit 12 indirectly.

Further, the heating stage 3 has a heater 3d for directly heating to soften the glass material 50. As this heater, there can be cited a heating element capable of performing radiation heating such as a cartridge heater, a ceramic heater, a SiC heater, and a carbon heater. It is also possible that the heating stage is configured by embedding these heaters in a metal plate of stainless steel, Ambiloy or the like or a glass tube of quartz or the like, for example.

Note that in the heating stage 3, the heating plate 3b is fixed to a bottom plate of the chamber 2 via a heat insulating plate 3c to prevent a heat of the heating plate 3b itself from being directly transferred to the chamber 2.

The pressing stage 4 of the embodiment has a pair of upper and lower pressing plates 4b. By reducing a distance between these pair of upper and lower pressing plates 4b, the upper mold unit 11 and the lower mold unit 12 are approximated, the plate-shaped glass material 50 mounted on the lower mold unit 12 is pressed in a softened state to be deformed, and forms of molding surfaces of the upper molds and the lower molds provided to the upper mold unit 11 and the lower mold unit 12 are transferred to the glass material 50, thereby molding glass casings. As a concrete configuration, this pressing stage 4 is configured by the pair of upper and lower pressing plates 4b having heaters 4a embedded therein. The pressing using the pressing plates 4b is conducted while maintaining the heating temperature at the pre-stage. It is also possible to provide, at positions between the pair of upper and lower pressing plates and heat insulating plates, cooling mechanism so that cooling rates of the plates and the molding molds can be controlled (so that cooling can be accelerated). As a cooling unit, an air-cooling system, a water-cooling system or the like can be employed.

More concretely, in the pressing stage 4, the upper and lower pressing plates 4b are connected to shafts 4d, and the shafts 4d enable a vertical movement of the pressing plates 4b with the use of a not-illustrated cylinder. By vertically moving the both of upper and lower plates (or the plate of either of the upper side and the lower side) of the pressing plates 4b as described above, the glass material 50 can be pressed by the molding molds by reducing the distance between the upper mold unit 11 and the lower mold unit 12. At this time, the pressing is conducted with a predetermined pressure, and it is possible to give the forms of glass casings to the plate-shaped glass material with high accuracy.

Note that these upper and lower pressing plates 4b are connected to the shafts 4d via heat insulating plates 4c to prevent a heat of the pressing plates 4b themselves from being directly transferred to the chamber 2. Note that it is also possible to design such that only one pressing plate out of the upper side and the lower side pressing plates can be moved, and the other pressing plate is fixed to the chamber 2, and in that case, the pressing plate 4b to be fixed may be fixed onto the chamber 2 via the heat insulating plate 4c to prevent the heat of the pressing plate 4b from being directly transferred to the chamber 2, similar to the heating plate 3b.

The cooling stage 5 of the embodiment has a cooling plate 5b having a heater 5a embedded therein, for cooling and solidifying the glass material 50 to which the forms of glass casings are given. This cooling plate 5b can cool the lower mold unit 12 by being brought into contact with the lower mold unit 12 after being subjected to the press processing, and can further cool the glass material 50 mounted on the lower mold unit 12 indirectly. Upper parts of the glass casings mounted on the lower mold unit 12 on the cooling plate 5b become an opened state, and there is a case where the cooling rate becomes too fast, so that it is also possible to control the cooling rate of the glass simple body by providing, on a part above the glass material 50, a heating source such as the heater 3d explained in the heating stage.

Note that in the cooling stage 5, the cooling plate 5b is fixed to the bottom plate of the chamber 2 via a heat insulating plate 5c to prevent a heat of the cooling plate 5b itself from being directly transferred to the chamber.

The solidification of the plate-shaped glass material 50 can be achieved by cooling the glass material to a glass transition point or lower of the material, more preferably to a strain point or lower of the material. When the plate-shaped glass material is sufficiently cooled, the form of the glass casing thereof is stabilized, and the deformation is suppressed. Here, the cooling indicates that the temperature is lowered until the plate-shaped glass material 50 is solidified so that the glass casing form can be stably given. The temperature is lower than that of the pressing plate only by about 50 to 150° C., and is still a high temperature, so that the cooling plate 5b is also provided with the heater 5a embedded therein.

Further, the pressing plates 4b are fixed to the shafts 4d via the heat insulating plates as described above, and the shafts 4d are connected to the cylinder. Here, the cylinder is only required to be able to vertically move the respective plates, and a cylinder such as an electric servo cylinder, a hydraulic cylinder, and an electric hydraulic cylinder can be used, for example.

A contact surface between each of the above-described heating plate 3b, the pressing plate 4b, and the cooling plate 5b and the molding molds is basically parallel to a horizontal plane. Particularly, in the pressing plate 4b, if the contact surface between the pressing plate 4b and the molding mold unit is inclined, positions of molding surfaces of the upper molds and the lower molds do not match, and forms of glass casings manufactured at this time sometimes become defective. Therefore, the management of plates in the respective stages and the alignment of the lower mold unit 12 are strictly conducted.

In these respective stages, the plate is formed in a manner that a cartridge heater is inserted into a material such as a stainless steel, cemented carbide, and an alloy steel and fixed. By heating the cartridge heater to increase the temperature of the plate, and the temperature can be maintained to a desired temperature.

Further, each of the heat insulating plates 3c, 4c, 5c of the respective stages may use a publicly-known heat insulating plate of ceramics, stainless steel, die steel, high-speed steel or the like, and is preferably made of ceramics having a high hardness and with which a deformation is difficult to occur even by a pressure and the like during the pressing, and a displacement is unlikely to occur. When a metal-based material is used, it is preferable to perform coating processing of CrN, TiN, or TiAlN on a surface.

The heating stage 3, the pressing stage 4, and the cooling stage 5 described above respectively form places (stages) in which the predetermined processing is conducted. In order to make the processing in the respective stages to be sequentially and smoothly conducted, the lower mold unit 12 is moved to and mounted on each stage at a predetermined timing by a conveying unit (not illustrated). The timing of the movement is controlled by a control unit.

More concretely, the predetermined processing is sequentially conducted while conveying and moving the lower mold unit 12 onto the respective plates in the order of the heating plate 3b, the pressing plate 4b, and the cooling plate 5b. Here, when the lower mold unit 12 is moved to the next stage, the stage after completing the processing becomes unoccupied, so that by further conveying the lower mold unit 12 on which another plate-shaped glass material is mounted, it is possible to make the molding operation of a plurality of glass casings continuously and simultaneously proceed.

As the above-described conveying unit for conducting the processing, a robot arm or the like can be cited, for example, although not illustrated. Such a conveying unit may be one capable of moving the lower mold unit 12 from the molding mold mounting table 8 to the heating stage 3, from the heating stage 3 to the pressing stage 4, from the pressing stage 4 to the cooling stage 5, and from the cooling stage 5 to the molding mold mounting table 9.

Note that this control unit controls even the movement of the molding molds, the temperatures of the plates in the respective heating stage, pressing stage and cooling stage, the timing of vertical movement and the like, and performs control so that a series of molding operations can be smoothly and continuously conducted. At this time, the opening and closing of the inlet shutter 6a and the outlet shutter 7a are also controlled. Further, it is preferable to control an amount, and a timing of supply of nitrogen so that the atmosphere in the chamber 2 is filled with inert gas.

Specifically, this molding apparatus 1 of the glass casings is a molding apparatus of glass casings that performs predetermined processing while raising and lowering the temperature at one or more of position(s) by conveying molding molds.

Further, a characteristic part of the molding apparatus 1 of the glass casings of the embodiment is that the molding mold units having the plurality of sets of molding molds are used, the respective molding molds are set to be able to move in the horizontal direction, and the alignment of the corresponding molding surfaces can be performed, as described above.

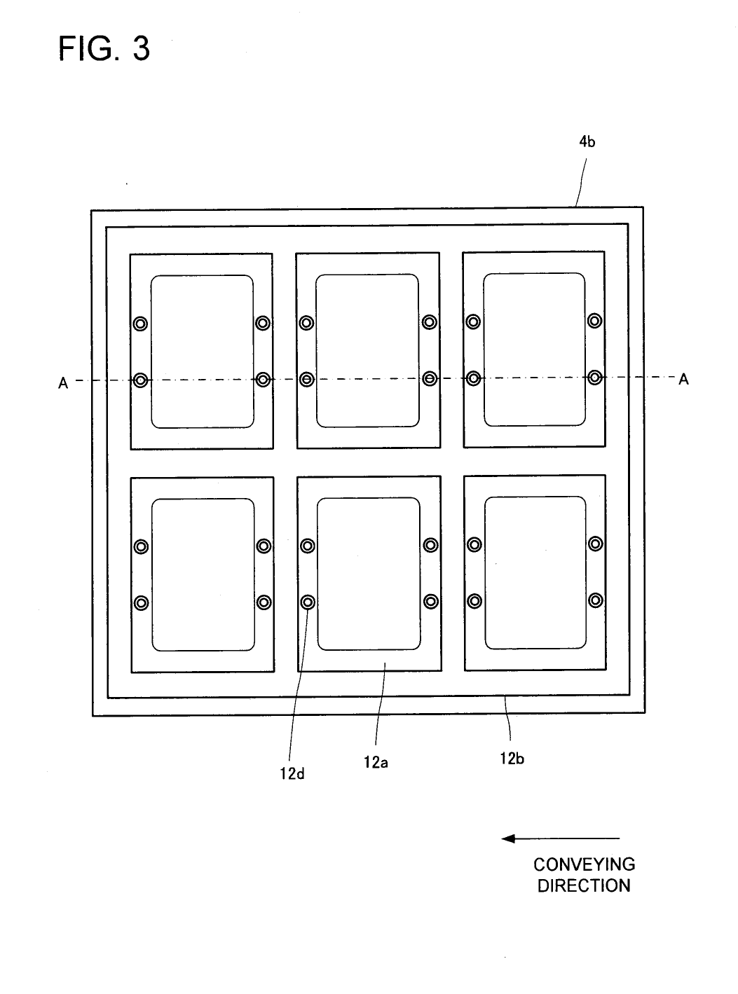

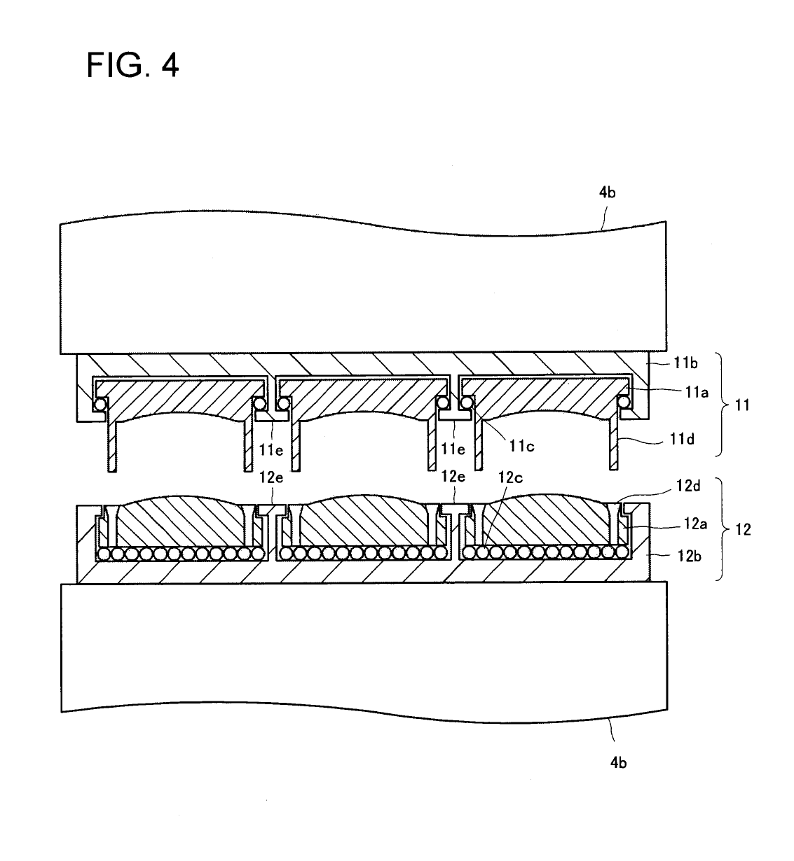

The configuration of this molding mold units will be described with reference to FIG. 3 and FIG. 4. FIG. 3 is a plan view when the lower mold unit 12 used in FIG. 1 is mounted on the pressing plate 4b, and FIG. 4 illustrates a cross sectional view of the molding mold units when seen at a cross section A-A in FIG. 3.

First, the configuration of the lower mold unit 12 will be described. The lower mold unit 12 is formed of a plurality of lower molds 12a, and a lower mold supporting member 12b which supports the lower molds 12a respectively and independently in a movable manner in the horizontal direction.

The lower mold supporting member 12b is configured to be provided with small chambers which house, in the inside thereof, the plurality of lower molds 12a by aligning the molds in respective predetermined positions. Regarding the small chamber, a wall that partitions the small chambers also has a function of regulating a movement of the lower mold 12a in the horizontal direction, and by setting such that the respective lower molds 12a can move only within a certain range, a positional relationship between the lower mold and the upper mold is set to fall within a predetermined range. Further, at this time, the lower mold unit 12 has openings to open the molding surfaces of the lower molds 12a directed upward so that the pressing operation is not hindered. Note that the openings are formed by a wall 12e that partitions the lower molds 12a, as illustrated in FIG. 4, and an upper part of the wall 12e is set to have a T-shape at cross section so that the lower mold 12a can be held within the small chamber. By employing this shape, the lower mold 12a and the glass material 50 are prevented from being remained to be adhered, and it is possible to securely cause a mold release after the pressing.

Further, the lower mold supporting member 12b supports, from below, the lower molds 12a via rolling members 12c. The rolling members 12c are preferably formed as spherical members with a uniform diameter. As the rolling member 12c, a true-spherical-shaped member with a diameter of 0.1 mm to 5 mm formed of a high-hardness material such as a high-carbon high-chromium steel product called as a bearing steel, ceramics such as silicon nitride (SiN), silicon carbide (SiC), zirconia (ZrO), and alumina (Al₂O₃), cermet containing tungsten carbide (WC), another metal or the like, is used.

The rolling member 12c made of these materials is preferably configured by using one type out of the above-described materials, but, it may also be configured by mixing a plurality of types made of different types of materials as long as it is possible to maintain a state where the lower mold 12a can be horizontally fixed.

Note that the shape of the rolling member 12c may also be set to, other than the true-spherical shape, a columnar shape, a flat spherical shape or the like, but, the true-spherical shape is the most preferable in terms of an easiness of processing, an easiness of achieving a height (diametral) accuracy, and an easiness of rolling of the rolling member 12c.

Note that in the present embodiment, the configuration of enabling the horizontal movement by the rolling members 12c is explained, but, the configuration is only required to be one in which the lower molds 12a can be respectively and independently moved in the horizontal direction. For enabling the horizontal movement, it is also possible to form a thin film, on a contact surface between the lower mold 12a and the lower mold supporting member 12b, by using a material which makes a friction coefficient to be small and improves slip between the mold and the member, for example. At this time, as the material of the thin film, diamond-like carbon (DLC), amorphous SiC, SiC, carbon nitride or the like can be cited.

The horizontal movement is preferably set such that the movement can be realized in any direction of 360 degrees so that the movement can be realized in accordance with a shrinkage direction of glass. Specifically, this is because the shrinkage direction is different depending on positions of the molding surfaces such that the shrinkage of glass occurs the least in the vicinity of a center of the glass material 50 (which is also a center part of the molding mold units), an outer periphery of the glass material 50 has a larger shrinkage amount, and further, a tendency of shrinkage becomes larger toward the center part of the molding mold units.

The lower mold 12a can move by an amount of gap provided between the lower mold 12a and the wall 12e of the small chamber of the lower mold unit 12 housing the mold. Here, a size of the gap is set to be larger than the shrinkage amount of the glass material 50 so that the lower mold 12a can sufficiently follow the shrinkage of the glass. If the lower mold cannot sufficiently follow the shrinkage of glass, an unnecessary stress is applied to the glass, which may lead to the defective form.

Further, the upper mold unit 11 has a structure similar to that of the above-described lower mold unit 12, and is configured by a plurality of upper molds 11a and an upper mold supporting member 11b holding the upper molds 11a in a movable manner in the horizontal direction. Note that the upper mold unit 11 is disposed so that the molding surfaces of the upper molds 11a and the lower molds 12a face each other, so that it supports in a manner that openings are directed downward and the molding surfaces of the upper molds 11a housed in the inside of the openings are also directed downward, opposite to the manner of the lower mold unit 12. Specifically, the upper mold unit 11 is used in a state as if the lower mold unit 12 is reversed upside down.

The upper mold supporting member 11b is configured to be provided with small chambers which house, in the inside thereof, the plurality of upper molds 11a by aligning the molds in respective predetermined positions. Regarding the small chamber, a wall that partitions the small chambers also has a function of regulating a movement of the upper mold 11a in the horizontal direction, and by setting such that the respective upper molds 11a can move only within a certain range, a positional relationship between the upper mold 11a and the lower mold 12a is set to fall within a predetermined range. Further, at this time, the upper mold unit 11 has the openings to open the molding surfaces of the upper molds 11a so that the pressing operation is not hindered. Note that the openings are formed by a wall 11e that partitions the upper molds 11a, as illustrated in FIG. 4, and a lower part of the wall 11e is set to have a T-shape at cross section so that the upper mold 11a can be held within the small chamber. By employing this shape, the upper mold 11a can be held within the small chamber so as not to fall.

Further, the upper mold supporting member 11b supports, from below, an outer periphery of the upper molds 11a via rolling members 11c. The rolling members 11c are similar to the rolling members used in the lower mold unit 12. Note that since the molding surfaces of the upper molds 11a are directed downward, the supporting position is set to an outer peripheral part which is not overlapped with the molding surface, so that the molding is not hindered.

Further, regarding each of the upper molds 11a and lower molds 12a housed in the upper mold unit 11 and the lower mold unit 12 described above, a concave portion for alignment is provided on one of the upper mold 11a and the lower mold 12a, and a convex portion for alignment is provided on the other, so that the positions of the respectively corresponding molding surfaces are aligned. In each of FIG. 3 and FIG. 4, a diagram in which convex portion 11ds for alignment are provided on the upper mold 11a, and concave portion 12ds for alignment are provided on the lower mold 12a, is illustrated, but, the concave and convex portions may also be provided in an opposite manner.

The concave portion 12ds and the convex portion 11 ds for alignment are provided to match the mutual molding surfaces, and are provided to corresponding positions. For example, as illustrated in FIG. 3, the concave portion 12ds or convex portion 11ds are provided at 2 positions respectively on each of outsides of both lateral opposed sides with respect to a rectangular molding surface. Note that the positions at which the concave portion and the convex portion are provided are not limited to this, and it is possible to provide the respective portions at two positions on adjacent sides, and other than the above, any disposition may be employed as long as the positions of the molding surfaces can be aligned.

When the upper mold unit 11 and the lower mold unit 12 are approximated at the time of pressing, the concave portion 12d and the convex portion 11d are fitted with each other before the pressing of the glass material 50, thereby setting the positions of the molding surfaces of the upper mold 11a and the lower mold 12a to the predetermined positions. Note that in order to make the concave portion 12d and the convex portion 11d to be fitted with each other easily and securely, it is preferable to enlarge an opening of the concave portion 12d on a side in which the convex portion 11d is inserted, by providing an inclination by which the opening becomes narrower as the convex portion 11d is inserted.

The concave portion 12d is only required to be able to sufficiently perform the alignment with respect to the molding surfaces of the upper mold 11a and the lower mold 12a, and although an example in which the concave portion 12d is provided on the lower mold 12a as a through hole is illustrated in FIG. 4, the embodiment is not limited to this. For example, it is also possible to form the concave portion 12d, on the lower mold 12a, as a hole which does not penetrate through the lower mold 12a, and it is also possible that in order to further sufficiently perform the alignment, the concave portion is provided even on the lower mold supporting member 12b, and the convex portion 11d for alignment of the upper mold 11a is provided to have a sufficiently long length. Note that when the concave portion is provided even on the lower mold holding member 12b, and the convex portion is inserted into the concave portion to perform the alignment, the rolling members 12c are preferably closely laid except for a portion through which the convex portion 11d passes, so that the insertion of the convex portion 11d is not hindered.

Note that the molding mold formed of the upper mold 11a and the lower mold 12a is configured by a material of cemented carbide, ceramics, stainless steel, carbon or the like. Further, each of the upper mold 11a and the lower mold 12a has the molding surface for transferring a form of surface of the glass casing to be molded, and the form of the molding surface is not particularly limited as long as it is a form realized as a casing of product. As the form of the casing, a form having a free curved surface is particularly preferable, and further, an axially asymmetric form of a casing to be obtained is preferable. Although it is difficult or it requires a lot of costs to manufacture the casing with such a complicated form depending on a conventional manufacture through polishing or the like, in the present invention, it is possible to manufacture the casing easily with a low cost through the press-molding.

Further, each of the upper mold supporting member 11b and the lower mold supporting member 12b is also configured by a material of cemented carbide, ceramics, stainless steel, carbon or the like.

Next, a molding method of the glass casings using the molding apparatus 1 of the glass casings will be described.

First, the lower mold unit 12 is mounted on the molding mold mounting table 8 on the inlet 6 side, and the plate-shaped glass material 50 is mounted on an upper part of the lower mold unit 12. The inlet shutter 6a is opened to open the inlet, and the lower mold unit 12 is conveyed onto the heating plate 3b by the conveying unit. When the lower mold unit 12 is conveyed, since it is brought into contact with the heating plate 3b on the lower side, a temperature of the unit is raised to a temperature same as that of the heating plate 3b. At the same time, the heater 3d is disposed above the conveyed lower mold unit 12 in the heating stage, and the glass material 50 mounted on the lower mold unit 12 is heated by the heater 3d through radiation heating.

At this time, the temperature of the heating plate 3b is set to fall within a temperature range of a glass transition point to a softening point of the glass material 50, and a temperature of the heater 3d is set to a temperature at which the glass material 50 can be heated to a temperature range of a deformation point to a melting point. By individually controlling the temperature ranges of heating to fall within the respectively different ranges as described above, the glass material 50 can be conveyed without being slack even in a sufficiently softened state for being pressed, from the heating step to the pressing step. Further, since the lower mold unit 12 can stably perform the pressing operation in the next pressing step, it is possible to obtain glass casings with a desired form. At this time, a rate of heating is preferably about 5 to 200° C./minute.

The lower mold unit 12 and the plate-shaped glass material 50 sufficiently heated in the heating stage 3 as described above are conveyed and mounted onto the pressing plate 4b on the lower side by a conveying unit. At this time, the pressing plate 4b is also heated to a temperature which is nearly equal to that of the heating plate 3b, so that the pressing can be conducted immediately.

When the pressing plate 4b on the upper side is lowered to reduce the distance between the pressing plates 4b, the convex portion 11d for alignment of the upper mold 11a is first inserted into the concave portion 12d of the lower mold 12a. At this time, positions of the convex portion 11d and the concave portion 12d are roughly aligned at a point of time at which the lower mold unit 12 is mounted on the pressing plate, but, there are a lot of cases where the positions are deviated more than a little. However, since the opening of the concave portion 12d is formed as a tapered opening, the positions can be aligned even if there is a deviation to some degree. Subsequently, when the convex portion 11d is further inserted into the concave portion 12d, the convex portion 11d and the concave portion 12d are set to be fitted with each other, and accordingly, the positions of the mutual molding surfaces can be correctly aligned, and the accuracy of form in each of the molding molds is increased.

The distance between the upper mold unit 11 and the lower mold unit 12 is further reduced, and the plate-shaped glass material 50 mounted on the upper part of the lower mold unit 12 is pressurized by the upper molds 11a and the lower molds 12a to be deformed. In the pressing step, the upper mold unit 11 and the lower mold unit 12 are approximated, and the pressure is applied from above and below the glass material 50, to thereby perform the pressing, as described above. Through the pressing, forms of the molding surfaces of the upper molds 11a and the lower molds 12a are transferred to the plate-shaped glass material 50, and the forms of the plurality of glass casings are given at a time. Note that if the glass material 50 is overlapped with the position corresponding to the convex portion 11d and the concave portion 12d, a through hole is formed on the glass material 50 so that the alignment of the molding surfaces is not hindered. When the through hole is provided to the glass material 50, it is required to be formed with a size large enough to prevent the convex portion 11d for alignment from being brought into contact with the glass material 50 when the portion is horizontally moved.

Further, in the pressing in this pressing step, the temperature of each of the upper molds 11a and the lower molds 12a is desirably set to a temperature between the glass transition point to the deformation point, and the temperature of the glass material 50 softened by the radiation heating is desirably set to a temperature of about the softening point. Further, the pressure applied to the plate-shaped glass material at the time of pressing is preferably 0.01 kN/mm² to 2 kN/mm², and is appropriately determined by taking a thickness, a molding form, a deformation amount and the like of the glass material into consideration.

Further, in the pressing step as described above, when the upper mold unit 11 and the lower mold unit 12 are approximated to the predetermined position, the temperatures of the upper and lower pressing plates 4b are lowered to lower the temperatures of the upper mold unit 11 and the lower mold unit 12 through heat transfer, so that the molded glass material 50 is released from the upper mold unit 11. The temperatures of the pressing plates 4b can be varied by the heaters 4a, and in order to release, after the pressing, the glass material 50 from the upper mold unit 11, the temperatures of the pressing plates 4b are lowered to a temperature less than the deformation point of the used glass material 50, and the temperatures of the upper molds 11a are also lowered to the nearly equal temperature. By the lowering of temperatures, the glass material is released by mainly utilizing a difference of shrinkage percentages of the upper molds 11a and the glass material 50. Further, it is also possible to provide a mechanism for forcibly causing the mold release to the upper mold unit 11 side, to thereby cause the mold release.

The glass material 50 after being released from the molds is mounted again on the lower mold unit 12, and is conveyed, together with the lower mold unit 12, from the pressing plate 4b to the cooling plate 5b by a conveying unit. This conveying unit is similar to the above-described conveying unit.

Next, the lower mold unit 12 is cooled by the cooling plate 5b, in which the lower mold unit 12 is cooled by being brought into contact with the cooling plate 5b on the lower side, similar to the above-described heating step. By cooling the lower mold unit 12, the glass material 50 whose contact area with the molding surfaces of the lower mold unit 12 is increased by being pressed, is cooled together with the lower mold unit 12.

Although the shrinkage amount of the glass material 50 is the largest during this cooling, the plurality of lower molds 12a provided to the lower mold unit 12 used in the embodiment can be respectively and independently moved in the horizontal direction, so that the cooling is conducted in a state where the lower molds 12a are moved in accordance with the shrinkage of the glass.

After the glass material 50 is sufficiently cooled, the outlet shutter 7a is opened from the chamber 2 to open the outlet 7, the lower mold unit 12 is taken out to the outside of the apparatus by a conveying unit, and is mounted on the molding mold mounting table 9 on the outlet 7 side.

At this time, the cooling is preferably performed to the glass transition point (Tg) or less of the plate-shaped glass material, and is more preferably performed to a temperature equal to or less than the strain point of the plate-shaped glass material. At this time, a rate of cooling is preferably about 5 to 150° C./minute.

As described above, the glass material 50 is molded into the forms of glass casings by being subjected to the series of operations configured by each of the heating process, the pressing process, and the cooling process, and in particular, the present invention has a characteristic in a point that the plurality of molding molds can be respectively and independently moved in the horizontal direction. Accordingly, the alignment is easy at the time of pressing, and during the cooling, by reducing the stress applied to the glass material in accordance with the shrinkage of the glass material, the generation of defective form such as a crack of the glass casing can be suppressed.

Note that it is preferable that the temperatures are changed in stages in each of the above-described heating step and cooling step, in which by providing one or more of heating stage(s) in the heating step, the temperature of the plate-shaped glass material is raised in stages, and the material is heated up to the molding temperature in the heating stage immediately before the pressing stage. Further, by providing one or more of cooling stage(s) also in the cooling step, the temperature of the plate-shaped glass material is lowered in stages, and is set to the temperature of 200° C. or less. By performing the heating and the cooling in stages as described above, a rapid temperature change of the plate-shaped glass material can be suppressed. By suppressing the temperature change, the occurrence of crack and strain is suppressed, and thus it is possible to prevent the characteristic of the glass casing from being impaired.

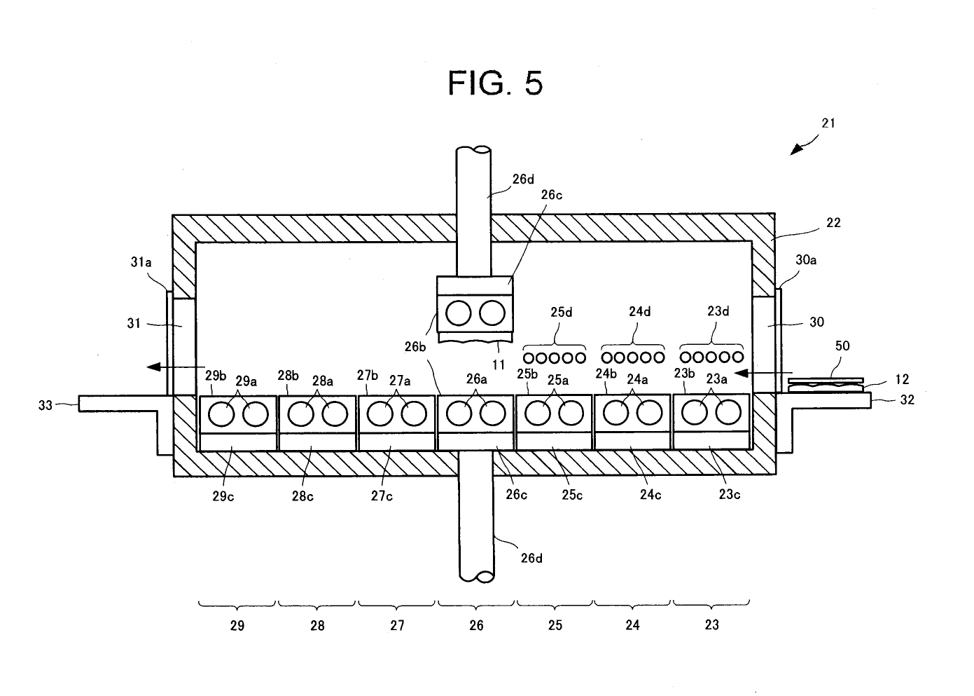

FIG. 5 illustrates an example of a molding apparatus of glass casings having a plurality of heating stages and cooling stages for conducting the heating step and the cooling step as described above. A molding apparatus 21 of glass casings illustrated in this FIG. 5 is configured as an apparatus having a chamber 22, a first heating stage 23, a second heating stage 24, a third heating stage 25, a pressing stage 26, a first cooling stage 27, a second cooling stage 28, and a third cooling stage 29. Further, to the chamber 22, an inlet 30 of the lower mold unit 12, an inlet shutter 30a which can open/close the inlet 30, an outlet 31, and an outlet shutter 31a which can open/close the outlet 31 are provided, and molding mold mounting tables 32 and 33 are provided to the outside of the inlet 30 and the outlet 31, similar to the molding apparatus 1 of the glass casings.

A configuration of the molding apparatus 21 of the glass casings is similar to that of the molding apparatus 1 of the glass casings in FIG. 1 except that the heating and the cooling are conducted in stages by providing the three heating stages and the three cooling stages.

In the first heating stage 23, a preliminary heating in which the plate-shaped glass material is once heated to a temperature equal to or less than a glass transition point, preferably a temperature lower than the glass transition point by about 50 to 200° C., is conducted, in the second heating stage 24, heating is conducted to a temperature between the glass transition point and a deformation point, and in the third heating stage 25, heating is performed to the deformation point or more of the glass, preferably to a softening point or a temperature higher than the softening point by about 5 to 150° C. Further, in the pressing stage 26, a molding operation with the use of molding molds is conducted while maintaining a molding temperature, to thereby give forms of glass casings. Further, in the first cooling stage 27, cooling is conducted to the glass transition point or less, preferably the strain point or less of the molded material, in the second cooling stage 28, cooling is further conducted to a temperature of 200° C. or less at which the molding molds are not oxidized, and in the third cooling stage 29, cooling is conducted to a room temperature.

Here, in the third cooling stage, by setting the plate to be used to a water-cooled plate in which a pipe through which cooling water circulates is provided, instead of heaters in the other stages, cooling can be efficiently conducted.

Thereafter, to the glass material obtained by being cooled, a plurality of aligned forms of glass casings are transferred, and in order to obtain individual forms of glass casings, the glass material is subjected to processing of cutting, polishing and the like to be produced as a final product.

As described above, according to the molding apparatus and the molding method of the glass casings of the embodiments of the present invention, it is possible to obtain a plurality of glass casings with high accuracy of form through a simple operation of press-molding of one time, and accordingly, the productivity of molded products can be improved, and the glass casings being final products can be stably manufactured at low cost.

A molding apparatus of glass casings of the embodiments of the present invention can be widely used at a time of manufacturing glass casings through press-molding.

Obviously, numerous modifications and variations of the present invention are possible in light of the above teachings. It is therefore to be understood that within the scope of the appended claims, the invention may be practiced otherwise than as specifically described herein.

What is claimed is:

1. A molding apparatus of glass casings, comprising, in a molding apparatus of glass casings capable of simultaneously molding a plurality of glass casings by sequentially conveying a plate-shaped glass material to each of a heating stage, a pressing stage and a cooling stage provided inside of a chamber, in which in the pressing stage, the glass material is press-molded using molding mold units formed of an upper mold unit having a plurality of upper molds and a lower mold unit having a plurality of lower molds,
an aligning unit aligning molding surfaces of the upper molds and the lower molds corresponded to each other to satisfy a predetermined positional relationship by horizontally moving the upper molds and the lower molds at the time of pressing, the upper molds and the lower molds being respectively and independently held within each unit in a movable manner in a horizontal direction by the upper mold unit and the lower mold unit.

2. The molding apparatus of the glass casings according to claim 1,
wherein, in the molding apparatus, the lower mold unit on which the glass material is mounted, is mounted on the respective heating stage, pressing stage and cooling stage, and a heating unit, a pressing unit and a cooling unit performing a heating process, a pressing process and a cooling process, respectively, on the mounted glass material, and a control unit controlling the respective heating process, pressing process and cooling process are provided;
the pressing unit corresponds to a pair of pressing plates configured by a lower pressing plate having the lower mold unit conveyed from the heating unit mounted on an upper surface thereof, and an upper pressing plate having the upper mold unit fixed to a lower surface thereof.

3. The molding apparatus of the glass casings according to claim 1,
wherein the lower mold unit has the plurality of lower molds, and a lower mold supporting member supporting bottom surfaces of the lower molds from below by rolling members by making molding surfaces of the plurality of lower molds to be directed upward.

4. The molding apparatus of the glass casings according to claim 3,
wherein the upper mold unit has the plurality of upper molds, and an upper mold supporting member supporting an outer periphery of the upper molds from below by rolling members by making molding surfaces of the plurality of upper molds to be directed downward.

5. The molding apparatus of the glass casings according to claim 1,
wherein the aligning unit is configured by a concave portion provided to either of the upper mold and the lower mold, and a convex portion provided to the other and fitted with the concave portion.

6. The molding apparatus of the glass casings according to claim 5,
wherein the concave portion is provided on the lower mold or the upper mold as a through hole.

7. The molding apparatus of the glass casings according to claim 3,
wherein the rolling member has a spherical shape and is made of SiN.

8. The molding apparatus of the glass casings according to claim 1,
wherein the glass casing is a molded product having a form of free curved surface.

9. The molding apparatus of the glass casings according to claim 8,
wherein the glass casing has an axially asymmetric form.

10. The molding apparatus of the glass casings according to claim 2,
wherein the heating unit is configured by a heating plate heating the lower molds through heat transfer, and a heater heating the glass material by radiation.

11. The molding apparatus of the glass casings according to claim 10,
wherein the heating unit individually controls a temperature of the heating plate and a temperature of the heater.

12. A molding method of glass casings, comprising:
a heating step of heating, by using the molding apparatus of the glass casings according to claim 1, after mounting the plate-shaped glass material on the lower mold unit, the lower mold unit and the glass material in the heating stage;
a pressing step of pressurizing the heated and softened glass material using the upper molds and the lower molds to transfer forms of the molding surfaces after performing alignment of the molding surfaces of the upper molds and the lower molds provided to the upper mold unit and the lower mold unit by vertically moving at least one of the pair of pressing plates being the pressing unit in the pressing stage; and
a cooling step of cooling, after the pressing step, the lower mold unit and the glass material to which the forms of the molding surfaces are transferred in the cooling stage, and horizontally moving the lower molds in accordance with a shrinkage of the glass material.

13. The molding method of the glass casings according to claim 12,
wherein, in the heating step, a heating control is individually conducted with respect to the lower molds and the glass material so that the lower molds are heated to a temperature range of a glass transition point to a softening point of the glass material, and the glass material is heated to a temperature range of a deformation point to a melting point.
